(19) United States
(12) Patent Application Publication
(10) Pub. No.: US 2019/0351692 A1
(43) Pub. Date: Nov. 21, 2019

(54) SADDLE-STITCH BOOKBINDING SYSTEM

(71) Applicant: Horizon International Inc., Takashima-shi, Shiga (JP)

(72) Inventors: Tatsuaki Ida, Takashima-shi (JP); Takakazu Hori, Takashima-shi (JP); Masayuki Kashiba, Takashima-shi (JP)

(73) Assignee: Horizon International Inc., Takashima-shi, Shiga (JP)

(21) Appl. No.: 16/474,229

(22) PCT Filed: May 12, 2017
(86) PCT No.: PCT/JP2017/017987

§ 371 Date: Jun. 27, 2019

(51) Int. Cl. B42B 4/00; B42C 19/02

(52) U.S. Cl. CPC B42B 4/00; B42C 19/02

(57) ABSTRACT

A folding machine folding a sheet P1 into a predetermined folding pattern to form a signature P3, a saddle stitching machine 3 arranged downstream of the folding machine to staple and fold the signature and a control unit 15 controlling the folding machine and saddle stitching machine are provided. The folding machine has parameters adjustable depending on a thickness of the sheet. The saddle stitching machine has parameters adjustable depending on a thickness of the signature P3, P4. The control unit sets the parameters of the folding machine based on the information about the thickness of the sheet and sets the parameters of the saddle stitching machine based on the information about the thickness of the signature calculated using the information about the thickness of the sheet and the information about the folding pattern of the folding machine.

### TECHNICAL FIELD

The present invention relates to a saddle-stitch bookbinding system.

### BACKGROUND ART

An example of conventional saddle-stitch bookbinding systems is disclosed in Patent Document 1.

The saddle-stitch bookbinding system disclosed in Patent Document 1 comprises a sheet supplying machine supplying sheets one by one from a stack of sheets, a folding machine folding the sheet supplied from the sheet supplying machine to form a signature, and a saddle stitching machine connected to an exit of the folding machine through a connection unit so as to staple and fold the signature.

The saddle stitching machine has a folding unit folding the signature supplied from the folding machine in two along a predetermined folding line.

The saddle stitching machine also has a stitching unit arranged downstream of the folding unit. The stitching unit is provided with a conveying mechanism conveying the two-folded signature in a saddle manner, and a stitcher arranged at a stitching position on a conveying path of the conveying mechanism to staple the two-folded signature at one or more predetermined positions on the folding line.

Thus the sheets are supplied one by one from the sheet supplying machine and folded by the folding machine to form a signature, thereafter the signature is folded in two, conveyed to the stitching position in a saddle manner and stapled by the saddle stitching machine. Next the stapled and two-folded signature is conveyed to a three side trimmer so as to be finished into a booklet.

In this saddle-stitch bookbinding system, the folding machine has one or more parameters adjustable depending on a thickness of the sheet and the saddle stitching machine has one or more parameters adjustable depending on a thickness of the signature.

Therefore, before the start of bookbinding, it is necessary to perform initial setting of the respective parameters of the folding machine and the saddle stitching machine according to the type of booklet to be bound.

However, in conventional saddle-stitch bookbinding systems, the initial setting of the respective parameters of the folding machine and the initial setting of the respective parameters of the saddle stitching machine are performed independently of each other, so that it takes time and effort to complete the initial setting of the parameters of the saddle-stitch bookbinding systems.

### PRIOR ART DOCUMENTS

### Patent Documents

Patent Document 1: JP 2014-151638 A

### SUMMARY OF THE INVENTION

### Problems to be Solved by the Invention

It is, therefore, an object of the present invention to provide a saddle-stitch bookbinding system whose initial setting of the parameters can be done easily and quickly.

### Means For Solving the Problems

In order to resolve the object, the present invention provides a saddle-stitch bookbinding system comprising: a folding machine folding a sheet into a predetermined folding pattern to forma signature; a saddle stitching machine arranged downstream of the folding machine to staple and fold the signature; and a control unit operatively connected to the folding machine and the saddle stitching machine, wherein the folding machine has one or more parameters adjustable depending on a thickness of the sheet and the saddle stitching machine has one or more parameters adjustable depending on a thickness of the signature, wherein the one or more parameters of the folding machine are set by the control unit based on the information about the thickness of the sheet, and the one or more parameters of the saddle stitching machine are set by the control unit based on the information about the thickness of the signature calculated by the control unit using the information about the thickness of the sheet and the information about the folding pattern of the folding machine.

According to a preferred embodiment of the present invention, the saddle stitching machine has: a folding unit taking in the signature from an entrance of the saddle stitching machine and folding the signature in two along a predetermined folding line; a stitching unit arranged downstream of the folding unit to staple the two-folded signature at one or more predetermined positions on the folding line; and a discharging unit arranged downstream of the stitching unit to convey the stapled and two-folded signature to an exit of the saddle stitching machine, wherein the stitching unit has: a conveying mechanism conveying the two-folded signature in a saddle manner; a stitcher arranged at a stitching position on a signature conveying path of the conveying mechanism to staple the two-folded signature at the one or more predetermined positions on the folding line; and a sensor arranged at the stitching position to detect the presence of a wire to be driven from the stitcher to the signature, wherein the discharging unit has: at least one press roller pair extending across a conveying path extended from the stitching unit to the exit of the saddle stitching machine; and/or at least one pair of conveyor belt pairs arranged parallel with the conveying path and spaced from each other in a width direction of the conveying path, the stapled and two-folded signature being conveyed between the at least one press roller pair and/or the respective conveyor belt pairs, wherein the one or more parameters of the saddle stitching machine are at least one of a length of the wire supplied to the stitcher at every stapling operation and a height of the sensor and a gap between the at least one press roller pair and a gap between the respective conveyor belt pairs.

### Effects of the Invention

According to the present invention, the one or more parameters of the folding machine are set based on the information about the thickness of the sheet and the one or more parameters are set based on the information about the thickness of the signature calculated from the information about the thickness of the sheet and the information about the folding pattern of the folding machine, and thereby the setting of the parameters of the saddle-stitch bookbinding system can be done easily and quickly.

### BRIEF DESCRIPTION OF THE DRAWINGS

FIG. 1 is a schematic perspective view of a saddle-stitch bookbinding system according to an embodiment of the present invention.

FIG. 2A is a schematic front view of a buckle-type folding unit and a sheet conveying unit of the folding machine of the saddle-stitch bookbinding system shown in FIG. 1 and a sheet supplying machine of the saddle-stitch bookbinding system.

FIG. 2B is a schematic perspective view of a knife-type folding unit of the folding machine of the saddle-stitch bookbinding system shown in FIG. 1.

FIG. 3A is a schematic front view of a stitcher of a saddle stitching machine of the saddle-stitch bookbinding system shown in FIG. 1.

FIG. 3B is a schematic front view of a sensor for detection of a wire and a sensor elevation mechanism of the saddle stitching machine of the saddle-stitch bookbinding system shown in FIG. 1.

FIG. 4A is a schematic front view of a press roller pair of the saddle stitching machine of the saddle-stitch bookbinding system shown in FIG. 1.

FIG. 4B is a schematic front view of a pair of conveyor belt pairs of the saddle stitching machine of the saddle-stitch bookbinding system shown in FIG. 1.

FIG. 4C is a schematic front view of a center brush of the saddle stitching machine of the saddle-stitch bookbinding system shown in FIG. 1.

### BEST MODE FOR CARRYING OUT THE INVENTION

A preferred embodiment of the present invention will be explained below with reference to the accompanying drawings.

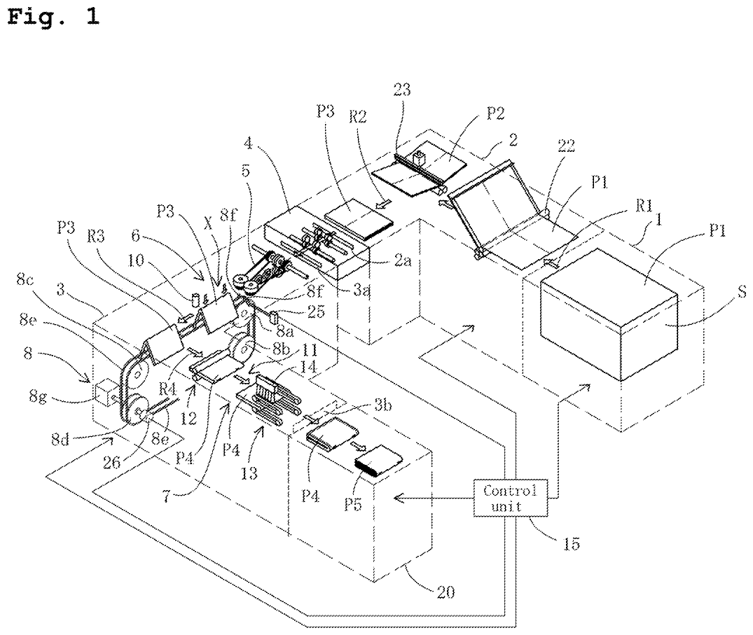

FIG. 1 is a schematic perspective view of a saddle-stitch bookbinding system according to an embodiment of the present invention.

As shown in FIG. 1, the saddle-stitch bookbinding system of the present invention comprises a sheet supplying machine 1 supplying sheets P1 one by one from a stack of sheets S, a folding machine 2 folding the sheet P1 supplied from the sheet supplying machine 1 to form a signature P3, a saddle stitching machine 3 stapling and folding the signature P3, and a connection unit 4 arranged between an exit 2a of the folding machine 2 and an entrance 3a of the saddle stitching machine 3 to convey the signature P3 from the folding machine 2 to the saddle stitching machine 3.

The folding machine 2 has a buckle-type folding unit 22 and a knife-type folding unit 23 which is arranged downstream of the buckle-type folding unit 22.

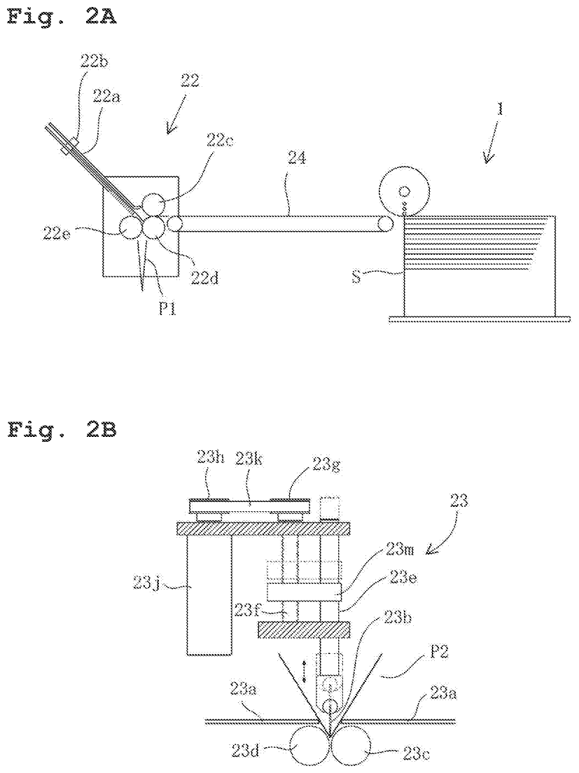

The buckle-type folding unit 22, as shown in FIG. 2A, has a single buckle 22a into which the sheet P1 is inserted by a length corresponding to a predetermined position for folding. The buckle 22a is provided with a stopper 22b whose position is adjustable. The sheet P1 collides with the stopper 22b at a leading end thereof so as to be positioned by the stopper 22b at the predetermined position for folding.

A pair of rollers 22c, 22d is arranged opposite to each other at an entrance of the buckle 22a so as to take in the sheet P1 to the buckle 22a, and a pair of rollers 22d, 22e is arranged opposite to each other at the entrance of the buckle 22a so as to fold a portion of the sheet P1 deflected from the buckle 22a.

As is clear from FIG. 2A, a sheet conveying unit 24 is arranged between the sheet supplying machine 1 and the buckle-type folding unit 22, and the sheet P1 supplied from the sheet supplying machine 1 is conveyed by the sheet conveying unit 24 to a gap between the roller pair 22c, 22d of the buckle-type folding unit 22.

The buckle-type folding unit 22 folds in two the sheet P1 supplied from the sheet supplying machine 1 along a direction perpendicular to the sheet supplying direction (indicated by an arrow R1) (see, a sheet P2).

A gap between each pair of rollers 22c, 22d; 22d, 22e of the buckle-type folding unit 22 is adjusted depending on a thickness of the sheet P1.

The knife-type folding unit 23, as shown in FIG. 2B, has a table 23a on which the sheet P2 is placed, a positioning means (not shown) positioning the sheet P2 at a predetermined folding position on the table 23a, a knife blade 23b and a pair of folding rollers 23c, 23d arranged opposite to each other with the table 23a therebetween at the folding position, and a knife elevation mechanism moving the knife blade 23b in a vertical direction through a slit between a first position above the table 23a and a second position close to a gap between the folding rollers 23c, 23d.

The knife elevation mechanism comprises a slide guide 23e arranged above the table 23a and aligned with the slit of the table 23a so as to be slidable in a vertical direction, and the knife blade 23b is attached to a lower end of the slide guide 23e. The knife elevation mechanism also comprises a ball screw 23f arranged parallel with the slide guide 23e and capable of rotating about an axis thereof in place and a pulley 23g attached coaxially to an upper end of the ball screw 23f.

The slide guide 23e is connected to a nut 23m of the ball screw 23f at a middle portion thereof.

The knife elevation mechanism further comprises a motor 23j, a pulley 23h mounted on a vertical drive shaft of the motor 23j, and a timing belt 23k extending between the pulley 23h and the pulley 23g.

Thus the ball screw 23f is rotated forward and reverse by the motor 23j and the resulting vertical movement of the slide guide 23e raises and lowers the knife blade 23b.

The knife-type folding unit 23 folds the sheet P2 in two along a direction perpendicular to the previous folding direction (the folding direction of the buckle-type folding unit 22) to form the signature P3, and discharges the signature P3 from the exit 2a of the folding machine 2 in a direction (indicated by an arrow R2) perpendicular to the sheet supplying direction of the sheet supplying machine 1.

The gap between the folding rollers 23c, 23d of the knife-type folding unit 23 is adjusted depending on the thickness of the sheet P2.

Although the folding machine 2 forms a signature by folding a sheet twice in this embodiment, a configuration of the folding machine 2 is not limited to this embodiment, and it is possible to arrange any type of folding machine which forms a signature by folding a sheet certain number of times (for example three or four times etc.).

The saddle stitching machine 3 has a folding unit 5 taking in the signature P3 from the entrance 3a of the saddle stitching machine 3 and folding the signature P3 into a mountain fold (folding the signature P3 in two) along a predetermined folding line, a stitching unit 6 arranged downstream of the folding unit 5 to staple the mountain-folded signature P3 at one or more predetermined positions on the folding line, and a discharging unit 7 arranged downstream of the stitching unit 6 to convey the stapled and two-folded signature P4 to the exit 3b of the saddle stitching machine 3.

The stitching unit 6 also has a conveying mechanism 8 conveying the mountain-folded signature P3 in a saddle manner, a stopper (not shown) positioning the signature P3 at a stitching position X on a signature conveying path of the conveying unit 8, a stitcher 9 arranged at the stitching position X to staple the two-folded signature P3 at one or more predetermined positions on the folding line of the signature P3, and a sensor 10 arranged downstream of the stitching position X to detect the presence of a wire to be driven from the stitcher 9 to the signature P3.

The conveying mechanism 8, as shown in FIG. 1, includes pairs of pulleys 8a, 8b; 8c, 8d spaced from each other in the signature conveying direction (indicated by an arrow R3) each of which is supported so as to be rotatable about a horizontal axis perpendicular to the signature conveying direction (the arrow R3). Each pair of pulleys 8a, 8b; 8c, 8d is composed of an upper pulley 8a, 8c and a lower pulley 8b, 8d which are vertically spaced from each other.

Endless belts 8e are extended between the pulleys 8a-8d, and a drive shaft of a motor 8g is coupled to an axis of one of the pulleys 8a-8d (in this embodiment, the pulley 8d). Further, feed claws 8f are fixed on the endless belts 8e at regular intervals.

Thus the endless belts 8e are circulated by the motor 8g through the pulleys 8a-8d in a vertical plane, and each time the signature P3 is supplied from the folding unit 5 onto the endless belts 8e, the feed claw 6f collides with a tail end of the signature P3, whereby the signature P3 is conveyed along an upper linear portion (a portion between the upper pulleys 8a and 8c) of the endless belts 8e in a saddle manner.

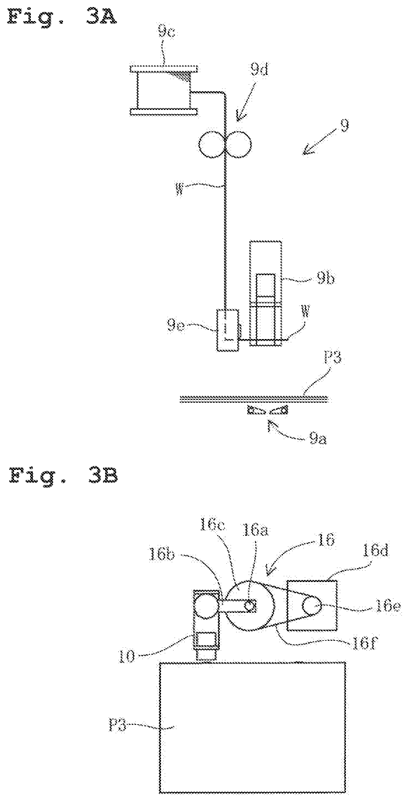

FIG. 3A is a schematic front view of the stitcher 9.

Referring to FIG. 3A, the stitcher 9 comprises a clincher 9a arranged under the stitching position X, a stitcher head 9b arranged opposite to the clincher 9a and movable between an elevated position spaced above the clincher 9a and a lowered position close to the clincher 9a, and a head elevation mechanism (not shown) moving the stitcher head 9b up and down.

The stitcher 9 further comprises a wire reel 9c, a wire feed roller pair 9d arranged between the wire reel 9c and the stitcher head 9b, a wire cutter 9e arranged between the wire feed roller pair 9d and the stitcher head 9b, and an interlocking linkage mechanism (not shown) interlocking the wire feed roller pair 9d and the wire cutter 9e with the vertical movement of the stitcher head 9b.

Then the signatures P3 are stopped in sequence at the stitching position X by the intermittent conveying motion of the conveying mechanism 8, and during the stop, the stitcher head 9b moves downward from the elevated position to the lowered position and moves upward to the elevated position.

While the stitcher head 9b moves downward from the elevated position to the lowered position, a predetermined length of a wire W previously supplied to the stitcher head 9b is bent into a U shape and the wire W for stapling the next signature P3 is newly fed into the stitcher head 9b by the predetermined length.

When the stitcher head 9b reaches the lowered position, the U-shaped wire W is driven into the signature P3 and a portion of the driven wire W protruding downward from the signature P3 is bent by cooperation of the stitcher head 9b and the clincher 9a whereby the signature P3 is stapled. At the same time, the predetermined length of the wire W newly fed into the stitcher head 9b is cut by the wire cutter 9e.

Thereafter, the stitcher head 9b moves upward from the lowered position to the elevated position while being loaded with the new wire W for stapling the next signature P3.

Further, the wire feed roller pair 9d and the wire cutter 9e are interlocked with the vertical movement of the stitcher head 9b by the interlocking linkage mechanism so that, when a height of the vertical movement of the stitcher head 9b is changed (a stroke length of the vertical movement is not changed), correspondingly a length of the wire W fed into the stitcher head 9b during downward movement of the stitcher head 9b is changed.

The length of the wire W fed into the stitcher head 9b is adjusted depending on the thickness of the signature P3 to be stapled.

FIG. 3B is a schematic front view of the sensor 10 and a sensor elevation mechanism 16.

Referring to FIG. 3B, in this embodiment, the sensor 10 is a proximity sensor. The sensor 10 is arranged above the signature conveying path and guided by a guide (not shown) so as to be movable in a vertical direction. The sensor 10 is moved up and down by the sensor elevation mechanism 16.

The sensor elevation mechanism 16 comprises a horizontal rotation axis 16a, a lever 16b fixed to the rotation axis 16a at one end thereof and pivotally connected to the sensor 10 at the other end thereof, and a pulley 16c concentrically mounted on the rotation axis 16a. The forward and reverse rotation of the pulley 16c causes the lever 16b to swing in a vertical plane so that the sensor 10 moves up and down.

The sensor elevation mechanism 16 further comprises a motor 16d, a pulley 16e mounted on a horizontal drive shaft of the motor 16d, and an endless belt 16f extending between the pulley 16e and the pulley 16c.

Thus the forward and reverse rotation of the motor 16d causes the lever 16b to swing so that a height of the sensor 10 measured from the signature conveying path is changed.

The height of the sensor 10 from the signature conveying path is adjusted depending on the thickness of the signature P4.

The discharging unit 7 is provided with a conveying path 11 extending from the stitching unit 6 to the exit 3b of the saddle stitching machine 3 in a direction (indicated by an arrow R4) perpendicular to the signature conveying direction (the arrow R3) of the conveying mechanism 8 of the folding unit 5.

The discharging unit 7 comprises at least one (in this embodiment, one) press roller pair 12 extending across the conveying path 11, and at least one pair (in this embodiment, one pair) of conveyor belt pairs 13, 13 arranged parallel with the conveying path 11 and spaced from each other in a width direction of the conveying path 11, and a center brush 14 arranged above the conveying path 11 and between the pair of conveyor belt pairs 13, 13.

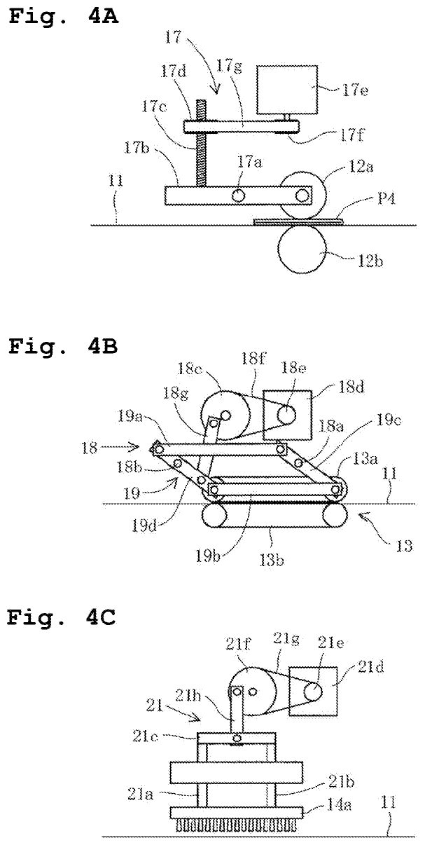

FIG. 4A is a schematic front view of the press roller pair 12 and FIG. 4B is a schematic front view of the pair of conveyor belt pairs 13, 13 and FIG. 4C is a schematic front view of the center brush 14.

Referring to FIG. 4A, the press roller pair 12 includes a horizontal lower roller 12b arranged in place under the conveying path 11 and extending across the conveying path 11, and an upper roller 12a extended above and parallel with the lower roller 12b and supported by a roller elevation mechanism 17 so as to be movable in a vertical direction.

The roller elevation mechanism 17 includes a pair of levers 17b arranged above the conveying path 11 and spaced from each other in a width direction of the conveying path 11. The upper roller 12a is supported between one ends of the pair of levers 17b.

A screw shaft 17c is pivotally connected to the other end of one of the pair of levers 17b at a lower end thereof, and a nut 17d is arranged in place to rotate in a horizontal plane and screwed into the screw shaft 17c.

The roller elevation mechanism 17 further includes a motor 17e, a pulley 17f mounted on a vertical drive shaft of the motor 17e, and an endless belt 17g extending between the nut 17d and the pulley 17f.

Thus the forward and reverse rotation of the nut 17d by the motor 17e causes the screw shaft 17c to move up and down, and the lever 17b is rotated about a rotation axis 17a by the vertical movement of the screw shaft 17c, so that a gap between the press roller pair 12 is changed.

The gap between the press roller pair 12 is adjusted depending on the thickness of the signature P4.

Referring to FIG. 4B, the pair of conveyor belt pairs 13 comprises a pair of lower conveyor belts 13b arranged in place under the conveying path 11 and spaced from each other in a width direction of the conveying path 11 and extending parallel with the conveying path 11, and a pair of upper conveyor belts 13a arranged above and parallel with the pair of lower conveyor belts 13b and supported by a conveyor belt elevation mechanism 18 so as to be movable up and down.

Front rollers of the pair of lower conveyor belts 13b are mounted on a common rotation axis while rear rollers of the pair of lower conveyor belts 13b are mounted on a common rotation axis. Also, front rollers of the pair of upper conveyor belts 13a are mounted on a common rotation axis while rear rollers of the pair of upper conveyor belts 13a are mounted on a common rotation axis.

For clarity, frames and drive mechanisms and so on of the upper and lower conveyors 13a, 13b are omitted in FIG. 4B.

The conveyor belt elevation mechanism 18 comprises a pair of parallel links 19. The parallel link 19 is composed of upper and lower links 19a, 19b which extend parallel with each other, and front and rear links 19c, 19d which extend parallel with each other and connect the upper and lower links 19a, 19b. The pair of parallel links 19 is spaced from each other in the width direction of the conveying path 11 and pivotally connected to horizontal axes 18a, 18b extending across the conveying path 11 at middle portions of the front and rear links 19c, 19d thereof.

Further, the rotation axis of the front rollers and the rotation axis of the rear rollers of the pair of upper conveyor belts 13a are supported by joint portions of the lower links 19b of the pair of the parallel links 19.

The conveyor belt elevation mechanism 18 also comprises a disc crank 18c arranged in place above the conveying path 11 so as to be rotatable in a vertical plane, a motor 18d, a pulley 18e mounted on a horizontal drive shaft of the motor 18d, and endless belt 18f extending between the disc crank 18c and the pulley 18e, and a link 18g connecting the disc crank 18c and a portion of the rear link 19d of one of the pair of parallel links 19, the portion being positioned below the rotation axis 18b.

Thus the forward and reverse rotation of the disc crank 18c by the motor 18d causes the front and rear links 19c, 19d of the pair of parallel links 19 to swing, and thereby the pair of upper conveyor belts 13a is moved up and down so that a gap between the respective conveyor belt pairs 13a, 13b.

The gap between the respective conveyor belt pairs 13a, 13b is adjusted depending on the thickness of the signature P4.

The center brush 14 comprises a brush 14a arranged above the conveying path 11 and a brush elevation mechanism 21 moving the brush 14a up and down.

The brush elevation mechanism 21 has guide rods 21a, 21b arranged to slide in a vertical direction and attached to the brush 14a at a lower end thereof, a connection member 21c connecting upper ends of the guide rods 21a, 21b, a disc crank 21f arranged in place above the conveying path 11 so as to be rotatable in a vertical plane, a motor 21d, a pulley 21e mounted on a horizontal drive shaft of the motor 21d, an endless belt 21g extending between the disc crank 21f and the pulley 21e, and a link 21h connecting the connection member 21c and the disc crank 21f.

Thus the forward and reverse rotation of the disc crank 21f by the motor 21d causes the guide rods 21a, 21b to slide so that the height of the brush 14a measured from the conveying path 11 is changed.

The height of the brush 14a from the conveying path 11 is adjusted depending on the thickness of the signature P4.

A control unit 15 is operatively connected to the sheet supplying machine 1, the folding machine 2, the saddle stitching machine 3 and the connection unit 4.

Before the start of the operation of the saddle-stich bookbinding system of the present invention, the parameters of the folding machine 2 adjustable depending on the thickness of the sheet P1 (in this embodiment, the gap between the respective roller pairs 22c, 22d; 22d, 22e of the buckle-type folding unit and the gap between the pair of folding rollers of the knife-type folding unit 23) are set by the control unit 15 based on the information about the thickness of the sheet P1, and the parameters of the saddle stitching machine 3 adjustable depending on the thickness of the signature P3, P4 (in this embodiment, the length of the wire W fed into the stitcher head 9b at every stapling operation of the stitcher 9, the height of the sensor 10, the gap between the press roller pair 12, the gap between the respective conveyor belt pairs 13a, 13b and the height of the center brush 14 (brush 14a)) are set by the control unit 15 based on the information about the thickness of the signature P3, P4 calculated by the control unit 15 using the information about the thickness of the sheet P1 and the information about the folding pattern of the folding machine 2.

Thus the one or more parameters of the folding machine 2 are set based on the information about the thickness of the sheet P1 and the one or more parameters are set based on the information about the thickness of the signature P3, P4 calculated from the information about the thickness of the sheet P1 and the information about the folding pattern of the folding machine 2, and thereby the setting of the parameters of the saddle-stitch bookbinding system can be done easily and quickly.

Also, before the start of the operation of the saddle-stitch bookbinding system, a time elapsed from the start of the sheet feed operation of the sheet supplying machine 1 to the detection of the signature P3 by a sensor 25 is measured by the control unit 15, and, based on the measured value and a processing speed of the saddle stitching machine 3, a value of timing of synchronizing the motion of the saddle stitching machine 3 with a series of motions from the sheet feed motion of the sheet supplying machine 1 to the signature feed motion of the connection unit 4, that is, a value of timing of supplying the next signature P3 from the connection unit 4 to the folding unit 5 when the two-folded signature P3 is fed into the stitching unit 6 of the saddle stitching machine 3 after the completion of folding the signature P3 in the folding unit 5 is calculated by the control unit 15. The calculated value of timing is stored in a memory of the control unit 15.

When the operation of the saddle-stitch bookbinding system is started, the control unit 15 sends a feed operation start command to the sheet supplying machine 1 every time a count value of a rotary encoder 16 corresponds to the timing value stored in the memory. As a result, a continuous operation of the sheet supplying machine 1, the folding machine 2 and the saddle stitching machine 3 is done.

Then the sheets P1 are supplied one by one from a stack of sheets S of the sheet supplying machine 1 to the folding machine 2, folded into the signature P3 by the folding machine 2 and supplied to the entrance 3a of the saddle stitching machine 3 from the exit 2a of the folding machine 2.

The signature P3 took in the saddle stitching machine 3 is folded in two by the folding unit 5, conveyed to the stitching position X along the signature conveying path by the conveying mechanism 8 of the stitching unit 6 and stapled by the stitcher 9.

The stapled and two-folded signature P4 is conveyed from the stitching position X to a downstream side of the signature conveying path by the conveying mechanism 8. At this time, the stapled and two-folded signature P4 passes under the sensor 10 and the wire W driven into the signature P4 is detected.

The stapled and two-folded signature P4 is delivered from the saddle stitching unit 6 to the discharging unit 7, passed through the gap between the press roller pairs 12, passed through the gap between the respective conveyor belt pairs 13 while being in contact with the center brush 14 (brush 14a) at an upper surface thereof and conveyed to the exit 3b of the saddle stitching machine 3. Further, the stapled and two-folded signature P4 is conveyed to a three side trimmer 20 arranged downstream of the saddle stitching machine 3, and trimmed by the three side trimmer 20 to finished into a booklet P5.

### DESCRIPTION OF REFERENCE NUMERALS

1 Sheet supplying machine
2 Folding machine
2a Exit
3 Saddle stitching machine
3a Entrance
3b Exit
4 Connection unit
5 Folding unit
6 Stitching unit
7 Discharging unit
8 Conveying mechanism
8a, 8c Upper pulley
8b, 8d Lower pulley
8e Endless belt
8f Feed claw
8g Motor
9 Stitcher
9a Clincher
9b Stitcher head
9c Wire reel
9d Wire feed roller pair
9e Wire cutter
10 Sensor
11 Conveying path
12 Press roller pair
12a Upper roller
12b Lower roller
13 Conveyor belt pair
13a Upper conveyor belt
13b Lower conveyor belt
14 Center brush
14a Brush
15 Control unit
16 Sensor elevation mechanism
16a Rotation axis
16b Lever
16c Pulley
16d Motor
16e Pulley
16f Endless belt
17 Roller elevation mechanism
17a Rotation axis
17b Lever
17c Screw shaft
17d Nut
17e Motor
17f Pulley
17g Endless belt
18 Conveyor belt elevation mechanism
18a, 18b Horizontal axis
18c Disc crank
18d Motor
18e Pulley
18f Endless belt
18g Link
19 Parallel link
19a Upper link
19b Lower link
19c Front link
19d Rear link
20 Three side trimmer
21 Brush elevation mechanism
21a, 21b Guide rod
21c Connection member
21d Motor
21e Pulley
21f Disc crank
21g Endless belt
21h Link
22 Buckle-type folding unit
22a Buckle
22b Stopper
22c, 22d Roller pair
22d, 22e Roller pair
23 Knife-type folding unit
23a Table
23b Knife blade
23c, 23d Folding roller
23e Guide rod
23f Ball screw
23g Pulley
23h Pulley
23j Motor
23k Timing belt
23m Nut
24 Sheet conveying unit
25 Sensor
26 Rotary encoder
P1, P2 Sheet
P3, P4 Signature
P5 Booklet
S Stack of sheets
W Wire

1. A saddle-stitch bookbinding system comprising:
a folding machine folding a sheet into a predetermined folding pattern to form a signature;
a saddle stitching machine arranged downstream of the folding machine to staple and fold the signature; and
a control unit operatively connected to the folding machine and the saddle stitching machine, wherein
the folding machine has one or more parameters adjustable depending on a thickness of the sheet and the saddle stitching machine has one or more parameters adjustable depending on a thickness of the signature, wherein
the one or more parameters of the folding machine are set by the control unit based on the information about the thickness of the sheet, and the one or more parameters of the saddle stitching machine are set by the control unit based on the information about the thickness of the signature calculated by the control unit using the information about the thickness of the sheet and the information about the folding pattern of the folding machine.

2. The saddle-stitch bookbinding system according to claim 1, wherein the saddle stitching machine has:
a folding unit taking in the signature from an entrance of the saddle stitching machine and folding the signature in two along a predetermined folding line;
a stitching unit arranged downstream of the folding unit to staple the two-folded signature at one or more predetermined positions on the folding line; and
a discharging unit arranged downstream of the stitching unit to convey the stapled and two-folded signature to an exit of the saddle stitching machine, wherein
the stitching unit has:
a conveying mechanism conveying the two-folded signature in a saddle manner;
a stitcher arranged at a stitching position on a signature conveying path of the conveying mechanism to staple the two-folded signature at the one or more predetermined positions on the folding line; and
a sensor arranged at the stitching position to detect the presence of a wire to be driven from the stitcher to the signature, wherein
the discharging unit has:
at least one press roller pair extending across a conveying path extended from the stitching unit to the exit of the saddle stitching machine; and/or
at least one pair of conveyor belt pairs arranged parallel with the conveying path and spaced from each other in a width direction of the conveying path,
the stapled and two-folded signature being conveyed between the at least one press roller pair and/or the respective conveyor belt pairs, wherein
the one or more parameters of the saddle stitching machine are at least one of a length of the wire supplied to the stitcher at every stapling operation and a height of the sensor and a gap between the at least one press roller pair and a gap between the respective conveyor belt pairs.
